(19) United States
(12) Patent Application Publication
(10) Pub. No.: US 2026/0217480 A1
(43) Pub. Date: Jul. 30, 2026

(54) TRAVELING VEHICLE AND TRAVELING VEHICLE SYSTEM

(71) Applicant: Murata Machinery, Ltd., Kyoto-shi, Kyoto (JP)

(72) Inventors: Yuji SHIMIZU, Kyoto-shi (JP); Hiroyuki HIRAKAWA, Kyoto-shi (JP)

(21) Appl. No.: 19/145,050

(22) PCT Filed: Oct. 25, 2023
(86) PCT No.: PCT/JP2023/038560

§ 371 Date: Jul. 1, 2025

(30) Foreign Application Priority Data
Jan. 12, 2023 (JP) 2023-003208

(51) Int. Cl. B65G 47/31; B65G 43/00

(52) U.S. Cl. CPC B65G 47/31; B65G 43/00; B65G 2203/0283; B65G 2203/0291; B65G 2203/041

(57) ABSTRACT

A traveling vehicle includes a body, a traveling unit assembly, an information output unit interface, an information acquirer, and a controller. The information output interface outputs second information according to a state of a preceding traveling vehicle acquired by the information acquirer in addition to first information according to a state of a subject vehicle. The controller is configured or programmed to control the traveling assembly of the subject vehicle based on both the first information and the second information output from the preceding traveling vehicle and acquired by the information acquirer.

### BACKGROUND OF THE INVENTION

### 1. Field of the Invention

The present invention relates to traveling vehicles and traveling vehicle systems.

### 2. Description of the Related Art

A transport vehicle system (traveling vehicle system) is known in which a plurality of transport vehicles (traveling vehicles) having sensors for forward monitoring travels on a predetermined path. For example, Japanese Unexamined Patent Publication No. 2007-25745 discloses a traveling vehicle including an LED array that switches display modes in accordance with a state of the subject vehicle, an imager that captures an image of an LED array provided in a traveling vehicle located in front of the subject vehicle, and a controller that acquires a state of the traveling vehicle ahead based on the display mode captured by the imager and controls a traveling assembly of the subject vehicle based on the acquired state. Such a traveling vehicle can quickly perform an operation according to the state of the traveling vehicle ahead.

### SUMMARY OF THE INVENTION

However, in order to further increase the traveling efficiency of the traveling vehicle, it is preferable to perform traveling based on not only the state of the traveling vehicle directly ahead in the traveling direction but also the state of the traveling vehicle two vehicles ahead in the traveling direction.

Example embodiments of the present invention provide traveling vehicles and traveling vehicle systems each capable of quickly executing operations according to states of a plurality of traveling vehicles located in front of a subject vehicle, but also improving the traveling efficiency of the subject vehicle.

A traveling vehicle according to an example embodiment of the present invention is a traveling vehicle usable in a traveling vehicle system including three or more traveling vehicles traveling in one direction along a predetermined traveling path, the traveling vehicle including a body, a traveling assembly configured to allow the body to travel along the traveling path, an information output interface configured to output information to a following traveling vehicle, an information acquirer configured to acquire the information output by the information output interface provided in a preceding traveling vehicle located directly ahead of a subject vehicle in a traveling direction, and a controller configured or programmed to control the traveling assembly, in which the information output interface is configured output, to the following traveling vehicle, first information according to a state of the subject vehicle and second information according to a state of the preceding traveling vehicle of the subject vehicle acquired by the information acquirer, and the controller is configured or programmed to control the traveling assembly based on both the first information and the second information output from the preceding traveling vehicle and acquired by the information acquirer.

The traveling vehicle with this configuration can transmit both the state of the subject vehicle and the state of the preceding traveling vehicle to the following traveling vehicle. This allows the following traveling vehicle to acquire the state (first information) of the traveling vehicle directly ahead of the subject vehicle in the traveling direction and the state (second information) of the traveling vehicle two vehicles ahead of the subject vehicle, and allows the traveling assembly to be controlled based on the states acquired. As a result, the operation according to the state of the traveling vehicle two vehicles ahead, which cannot be directly detected, can also be promptly executed, so that the traveling efficiency of the subject vehicle can be improved.

In a traveling vehicle according to an example embodiment of the present invention, the information output interface may include a display configured to switch display modes in accordance with the information, the information acquirer may include an imager configured to capture an image of the display provided in the preceding traveling vehicle, the display may be configured to switch display modes based on the first information and the second information, and the controller may be configured or programmed to control the traveling assembly of the subject vehicle based on a display mode of the display of the preceding traveling vehicle captured by the imager. With this configuration, the information can be stably transmitted and responsiveness can be enhanced.

In a traveling vehicle according to an example embodiment of the present invention, the controller may be configured or programmed to control the traveling assembly to decelerate to a first speed when a distance to the preceding traveling vehicle reaches a first predetermined distance, and may be configured or programmed to control the traveling assembly to stop when the distance reaches a second predetermined distance shorter than the first predetermined distance. This configuration can prevent the traveling vehicles from colliding with each other.

In a traveling vehicle according to an example embodiment of the present invention, the information output interface may be configured to switch the information to be output in accordance with a traveling state of the subject vehicle and a traveling state of the preceding traveling vehicle, and the traveling state may include an accelerated state and a decelerated state. With this configuration, it is possible to transmit, to the following traveling vehicle, whether the subject vehicle is in the accelerated state or the decelerated state, and it is also possible to transmit, to the following traveling vehicle, whether the preceding traveling vehicle of the subject vehicle is in the accelerated state or the decelerated state.

In a traveling vehicle according to an example embodiment of the present invention, the information output interface may be configured to switch the information to be output in accordance with a traveling state of the subject vehicle and a traveling state of the preceding traveling vehicle, and the traveling state may include an abnormal stop state and a normal stop state. Incidentally, the abnormal stop state herein refers to a state in which the vehicle has transitioned to the operation for an abnormal stop, and does not necessarily have to be a stopped state. Similarly, the normal stop state herein refers to a state in which the vehicle has transitioned to the operation for a normal stop, and does not necessarily have to be the stopped state. The difference between the abnormal stop and the normal stop is a distance (braking distance) from when the vehicle transitions to each operation to when the vehicle completely stops, and the distance for the case of abnormal stop is shorter than the distance for the case of normal stop. With this configuration, it is possible to transmit, to the following traveling vehicle, whether the subject vehicle is abnormally stopped or normally stopped, and it is also possible to transmit, to the following traveling vehicle, whether the preceding traveling vehicle of the subject vehicle is abnormally stopped or normally stopped.

A traveling vehicle system according to an example embodiment of the present invention is a traveling vehicle system including the traveling vehicle described above, in which three traveling vehicles included in the traveling vehicle system and traveling in succession are assumed to correspond to a traveling vehicle located at a front being a first traveling vehicle, a traveling vehicle located in a middle being a second traveling vehicle and a traveling vehicle located at a rear being a third traveling vehicle, and, the third traveling vehicle may acquire both a state of the first traveling vehicle and a state of the second traveling vehicle based on the information output by the information output interface of the second traveling vehicle, the third traveling vehicle may perform traveling control based on both the state of the first traveling vehicle and the state of the second traveling vehicle, and further, the third traveling vehicle may output both a state of a subject vehicle and the state of the second traveling vehicle from the information output interface of the subject vehicle. This configuration makes it possible to transmit, to the third traveling vehicle located behind, both the state of the first traveling vehicle and the state of the second traveling vehicle. This allows the third traveling vehicle located behind, which has acquired both the state of the first traveling vehicle and the state of the second traveling vehicle, to not only follow the second traveling vehicle directly ahead of the subject vehicle in the traveling direction but also control the traveling assembly based on the state of the first traveling vehicle two vehicles ahead. As a result, the operation according to the states of the traveling vehicles located in front of the third traveling vehicle can be promptly executed, and further, the traveling efficiency of the traveling vehicle traveling as the traveling vehicle system can be improved.

According to example embodiments of the present invention, it is possible to quickly execute operations according to states of a plurality of traveling vehicles located in front of the subject vehicle and improve the traveling efficiency of the subject vehicle.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic plan view illustrating a traveling vehicle system according to an example embodiment of the present invention.

FIG. 2 is a schematic front view of an overhead traveling vehicle of FIG. 1.

FIG. 3 is a rear view of a body of the overhead traveling vehicle of FIG. 1.

FIG. 4 is a block diagram illustrating a functional configuration of the traveling vehicle system of FIG. 1.

FIG. 5 is a diagram illustrating a mirror provided at a branch portion.

FIG. 6 is a diagram illustrating a mirror provided at a merging portion.

### DETAILED DESCRIPTION OF THE EXAMPLE EMBODIMENTS

Hereinafter, overhead traveling vehicles (traveling vehicles) 6 and traveling vehicle systems 1 according to example embodiments will be described with reference to the drawings. In the description of the drawings, the same elements are denoted by the same reference numerals, and redundant description is omitted.

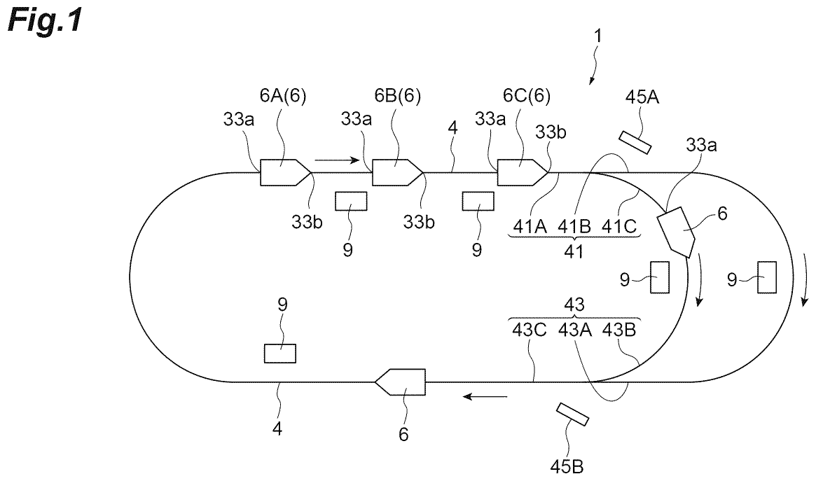

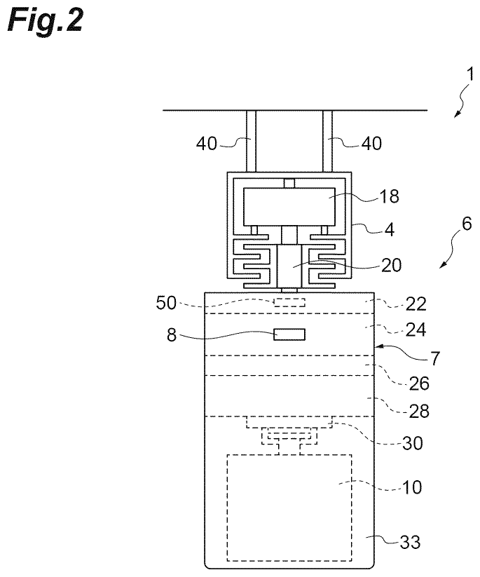

The traveling vehicle system 1 is a system to transport, by using the overhead traveling vehicle 6 capable of moving along a track (predetermined traveling path) 4, for example, an article 10 (see FIG. 2) between placement sections 9 and 9. Examples of the article 10 include containers such as a front opening unified pod (FOUP) to store a plurality of semiconductor wafers and a reticle pod to store a glass substrate, and common parts. Here, for example, in a factory or the like, the traveling vehicle system 1 in which, for example, the overhead traveling vehicle 6 (hereinafter simply referred to as “traveling vehicle 6”) travels along the one-way track 4 that is on a ceiling or the like of the factory will be described as an example. As illustrated in FIG. 1, the traveling vehicle system 1 includes the track 4, mirrors 45A and 45B, a plurality of traveling vehicles 6, and the plurality of placement sections 9.

As illustrated in FIG. 2, the track 4 is laid, for example, near a ceiling which is a space above a worker's head. The track 4 is, for example, suspended from the ceiling. The track 4 is a predetermined traveling path for the traveling vehicle 6 to travel on. The track 4 is supported by supports 40 and 40.

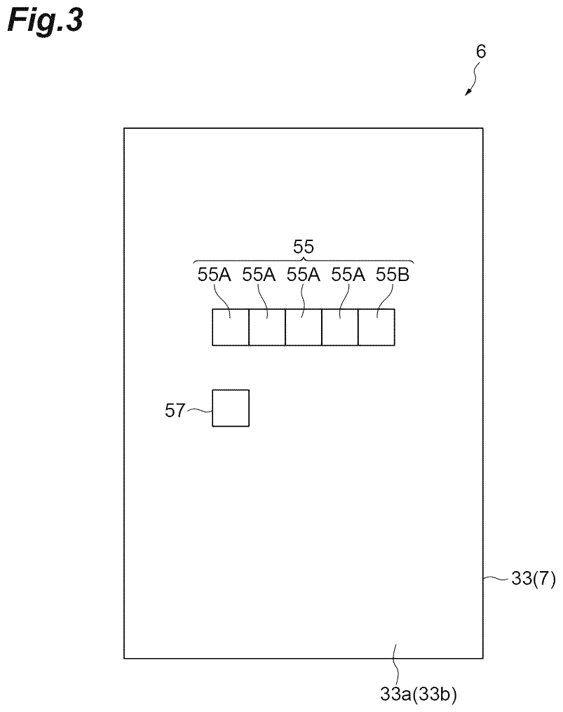

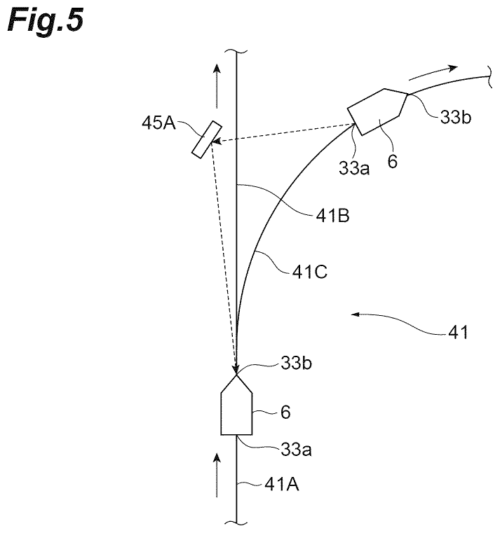

As illustrated in FIG. 1, the mirrors 45A and 45B (for example, wide-angle mirrors) are provided along the track 4 and reflect a light emitting diode (LED) array (display) 55 (see FIG. 3) provided in the traveling vehicle 6. The track 4 includes a branch portion 41 including an inflow path 41A that flows into a predetermined position along one direction, a first outflow path 41B that flows out from the predetermined position along one direction, and a second outflow path 41C that flows out from the predetermined position in a direction different from that one direction. The mirror 45A is in the vicinity (side) of the branch portion 41. As illustrated in FIG. 5, the mirror 45A reflects the LED array 55 provided on a fall-prevention cover 33a of the traveling vehicle 6 on the second outflow path 41C as viewed from the traveling vehicle 6 located on the inflow path 41A.

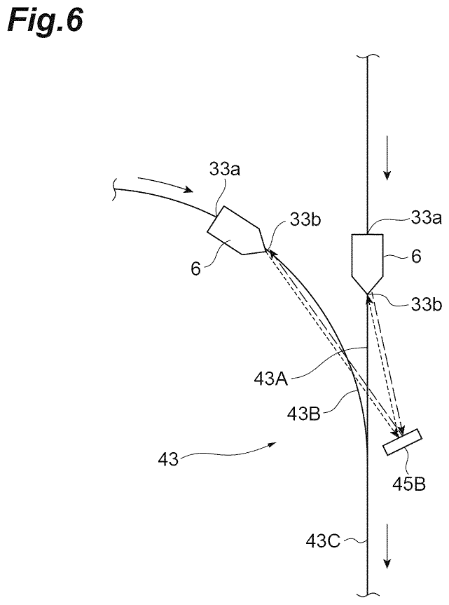

In addition, as illustrated in FIG. 1, the track 4 includes a merging portion 43 including a first inflow path 43A that flows in along one direction toward a predetermined position, a second inflow path 43B that flows in from a direction different from that one direction toward the predetermined position, and an outflow path 43C that flows out from the predetermined position in a direction different from that one direction. The mirror 45B is in the vicinity of the merging portion 43. As illustrated in FIG. 6, the mirror 45B reflects the LED array 55 provided on a fall-prevention cover 33b of the traveling vehicle 6 on the second inflow path 43B as viewed from the traveling vehicle 6 located on the first inflow path 43A, and also reflects the LED array 55 provided on the fall-prevention cover 33b of the traveling vehicle 6 on the first inflow path 43A as viewed from the traveling vehicle 6 located on the second inflow path 43B.

As illustrated in FIG. 2, the traveling vehicle 6 travels along the track 4 and transports the article 10. The traveling vehicle 6 is configured so that the article 10 can be transferred. The traveling vehicle 6 is an automated overhead transport vehicle. The number of traveling vehicles 6 included in the traveling vehicle system 1 is not particularly limited and preferably is three or more, for example. As illustrated in FIGS. 2 and 3, the traveling vehicle 6 includes a body 7, a traveling assembly 18, the LED array (information output interface) 55, an identifier 57, an imager (information acquirer) 8, and a controller 50.

A lateral feeder 24 laterally feeds a θ drive 26, an elevation driver 28, and an elevation platform 30 collectively in a direction perpendicular to the traveling direction of the track 4. The θ drive 26 turns at least one of the elevation driver 28 and the elevation platform 30 within a predetermined angle range in a horizontal plane. The elevation driver 28 elevates and lowers the elevation platform 30 by reeling or unreeling a hanger such as a wire, rope, or belt. The elevation platform 30 includes a chuck and can freely grip or release the article 10. For example, a pair of fall-prevention covers 33 is provided at the front and the rear of the traveling vehicle 6 in the traveling direction. The fall-prevention cover 33 extends and retracts a claw or the like (not illustrated) below the article 10 to be transported, thus preventing the article 10 from dropping during transportation.

As illustrated in FIGS. 1 and 2, the placement sections 9 are arranged along the track 4 and provided at locations where the article 10 can be delivered to and from the traveling vehicle 6. The placement sections 9 each include a buffer and a delivery port. The buffer is a placement section on which the article 10 is temporarily placed. The buffer is a placement section on which the article 10 is temporarily placed, for example, when the article 10 transported by the traveling vehicle 6 is unable to be transferred to a target delivery port, for example, for the reason that another article 10 has been placed on the target delivery port. The delivery port is, for example, a placement section to deliver the article 10 to and from a semiconductor processing device (not illustrated) such as a cleaning device, a deposition device, a lithography device, an etching device, a thermal treatment device, and a planarization device. The processing device is not limited to a specific device and may be a variety of devices.

For example, the placement sections 9 are arranged to a side of the track 4. In this case, the traveling vehicle 6 delivers the article 10 to and from the placement section 9, by laterally feeding the elevation driver 28 or the like by the lateral feeder 24 and by slightly elevating and lowering the elevation platform 30. Although not illustrated, the placement section 9 may be located immediately below the track 4. In this case, the traveling vehicle 6 elevates and lowers the elevation platform 30 to deliver the article 10 to and from the placement section 9.

As illustrated in FIG. 3, the LED array 55 is located on the fall-prevention cover 33a (33) provided on the rear side of the traveling vehicle 6. The LED array 55 may also be located on the fall-prevention cover 33b (33) provided on the front side of the traveling vehicle 6. The LED array 55 is an LED assembly in which a plurality of (five) LEDs 55A and 55B are arranged. The LED array 55 switches display modes (outputs both first information and second information) based on both a state of the subject traveling vehicle 6 (traveling vehicle 6 provided with the LED array 55) and a state of the traveling vehicle (preceding traveling vehicle) 6 located directly ahead of the subject vehicle in the traveling direction (hereinafter, also referred to as a “preceding traveling vehicle 6”). In other words, by looking at the display mode of the LED array 55 of the traveling vehicle 6, it is possible to identify or determine both the state of the traveling vehicle 6 provided with that LED array 55 and the state of the traveling vehicle 6 located directly ahead of the traveling vehicle 6.

The LED array 55 changes the display mode with a combination of the LED 55A that is illuminated and the LED 55A that is not illuminated among the four LEDs 55A (hereinafter, simply referred to as “combination of illumination”). The remaining one LED 55B is used as a parity. That is, the LED 55B is used to determine whether a combination of illumination of the four LEDs 55A is the display mode intended by the controller 50. The switching of display modes in the LED array 55 is performed by the controller 50.

The identifier 57 is located in the vicinity of (adjacent to) the LED array 55. The identifier 57 is a predetermined symbol (mark). The identifier 57 may be, for example, a two-dimensional barcode or the like, and may include information such as an identification number to distinguish each of the plurality of traveling vehicles 6.

The imager 8 captures an image of the LED array 55 provided in the traveling vehicle 6 located in front of the subject traveling vehicle 6. The imager 8 is provided on the fall-prevention cover 33b (33) provided on the front side of the traveling vehicle 6. The imager 8 transmits, to the controller 50, a captured image obtained by imaging the display mode of the LED array 55. As will be described later, in some cases, the imager 8 not only captures an image of the LED array 55 provided on the traveling vehicle 6 located in front of the subject traveling vehicle 6, but also captures an image of the LED array 55 reflected via the mirrors 45A and 45B arranged along the track 4.

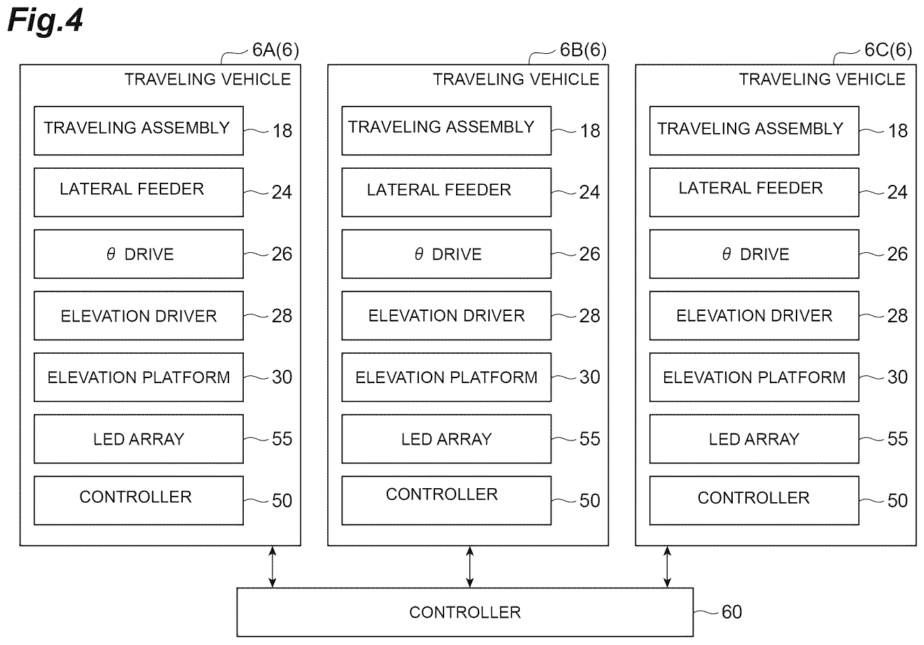

The controller 50 may be an electronic controller including a central processing unit (CPU), a read only memory (ROM), and a random access memory (RAM). The controller 50 is configured or programmed to control various operations in the traveling vehicle 6. Specifically, as illustrated in FIG. 4, the controller 50 is configured or programmed to control the traveling assembly 18, the lateral feeder 24, the θ drive 26, the elevation driver 28, the elevation platform 30, and the LED array 55. The controller 50 can be configured as, for example, software in which a program stored in the ROM is loaded onto the RAM and executed by the CPU. The controller 50 may be configured as hardware such as an electronic circuit. The controller 50 communicates with a controller 60 using a communication line (feeder line) of the track 4 or the like.

The controller 50 is configured or programmed to control the traveling assembly 18 to decelerate to a first speed when a distance to the preceding traveling vehicle 6 reaches a first predetermined distance, and to control the traveling assembly 18 to stop when the distance reaches a second predetermined distance shorter than the first predetermined distance. In some cases, the controller 50 is configured or programmed to control the traveling assembly 18 to accelerate to a predetermined speed when the distance to the preceding traveling vehicle 6 is the first predetermined distance or more. The distance to the preceding traveling vehicle 6 can be acquired by an obstacle sensor or the like. In this type of control, for example, even if the preceding traveling vehicle 6 starts decelerating, the traveling vehicle 6 cannot decelerate until it approaches the preceding traveling vehicle 6 by the predetermined distance. Thus, the traveling vehicle 6 cannot start decelerating immediately at the timing when the preceding traveling vehicle 6 starts decelerating. For this reason, in order to avoid a collision with the preceding traveling vehicle 6, the traveling vehicle 6 needs to travel with a long inter-vehicle distance, which leads to a problem of a decrease in transport capability. Therefore, in the present example embodiment, in addition to the above control, the following control is performed.

The controller 50 switches the display modes of the LED array 55 in accordance with the traveling state of the subject vehicle and the traveling state of the preceding traveling vehicle 6. Specifically, for example, the controller 50 receives a command from the controller 60 to acquire the traveling state (accelerated state or decelerated state) of the subject vehicle. In addition, the controller 50 acquires the traveling state (accelerated state or decelerated state) of the preceding traveling vehicle 6 based on the display mode of the LED array 55 of the preceding traveling vehicle 6 imaged by the imager 8. The controller 50 is configured or programmed to control illumination of the LEDs 55A in the LED array 55 so as to show a display mode corresponding to a combination of the traveling state (accelerated state or decelerated state) of the subject vehicle and the traveling state (accelerated state or decelerated state) of the preceding traveling vehicle 6 acquired as described above. That is, by switching the display modes of the LED array 55 provided on the traveling vehicle 6, the controller 50 transmits the traveling state of the subject vehicle and the traveling state of the preceding traveling vehicle 6 to the following traveling vehicle 6.

Based on the display mode captured by the imager 8, the display mode captured by the imager 8 via the mirror 45A, or the display mode captured by the imager 8 via the mirror 45B, the controller 50 acquires the traveling state of the traveling vehicle 6 directly ahead (preceding traveling vehicle 6) of the subject vehicle in the traveling direction and the state of the traveling vehicle 6 two vehicles ahead of the subject vehicle in the traveling direction. The controller 50 is configured or programmed to control the traveling assembly 18 based on the traveling state of the traveling vehicle 6 directly ahead of the subject vehicle and the traveling state of the traveling vehicle 6 two vehicles ahead of the subject vehicle acquired via the imager 8.

Specifically, the controller 50 acquires the traveling state of the traveling vehicle 6 directly ahead of the subject vehicle and the traveling state of the traveling vehicle 6 two vehicles ahead of the subject vehicle based on the mode of the LED array 55 of the traveling vehicle 6 directly ahead of the subject vehicle captured by the imager 8. For example, the controller 50 extracts a combination of illumination of the LED array 55 from the captured images acquired, and compares the traveling state of the traveling vehicle 6 directly ahead of the subject vehicle, the traveling state of the traveling vehicle 6 two vehicles ahead of the subject vehicle, and the combination of illumination with the combination information stored in association with each other. This allows the controller 50 to acquire the traveling state of the traveling vehicle 6 directly ahead of the subject vehicle and the traveling state of the traveling vehicle 6 two vehicles ahead of the subject vehicle.

The controller 50 is configured or programmed to control the traveling assembly 18 according to the mode of the LED array 55 of the traveling vehicle 6 directly ahead of the subject vehicle acquired via the imager 8. More specifically, the controller 50 is configured or programmed to control the traveling assembly 18 according to the acquired traveling state of the traveling vehicle 6 directly ahead of the subject vehicle and the acquired traveling state of the traveling vehicle 6 two vehicles ahead of the subject vehicle. For example, when acquiring that the traveling state of the traveling vehicle 6 two vehicles ahead of the subject vehicle is the decelerated state and the traveling state of the traveling vehicle 6 directly ahead of the subject vehicle is the accelerated state or a normal traveling state, the controller 50 decelerates the traveling assembly 18 without following the traveling state of the traveling vehicle 6 directly ahead of the subject vehicle. Incidentally, the normal traveling state refers to a state in which the vehicle travels at a constant speed without accelerating or decelerating.

The controller 50 determines whether to control the traveling assembly 18 based on the positional relationship between the LED array 55 and the identifier 57 in the captured image acquired by the imager 8. For example, in a case where the identifier 57 is recognized at a predetermined position (for example, the lower left of the LED array 55) with respect to the LED array 55 in the captured image, the controller 50 acquires the traveling state of the traveling vehicle 6 directly ahead of the subject vehicle and the traveling state of the traveling vehicle 6 two vehicles ahead of the subject vehicle from the captured image acquired, and controls the traveling assembly 18 according to the traveling states. On the other hand, in a case where the identifier 57 is not recognized at the predetermined position with respect to the LED array 55 in the captured image, the controller 50 does not control the traveling assembly 18 based on the captured image acquired. That is, the controller 50 determines that the acquired display mode is not the one acquired from the LED array 55 provided on the preceding traveling vehicle 6, and does not control the traveling assembly 18.

The controller 50 also determines whether the display mode is a mirror image reflected on the mirrors 45A and 45B based on the positional relationship between the LED array 55 and the identifier 57 in the captured image acquired by the imager 8. For example, in a case where the identifier 57 is recognized at a predetermined position (for example, the lower left of the LED array 55) with respect to the LED array 55 in the captured image, the controller 50 determines that it is a captured image (mirror image) in which the LED array 55 of the preceding traveling vehicle 6 is captured, not via the mirrors 45A and 45B. On the other hand, in a case where the identifier 57 is not recognized at the predetermined position with respect to the LED array 55 in the captured image, the controller 50 determines that it is a captured image (mirror image) captured via the mirrors 45A and 45B. This allows the controller 50 to distinguish whether the acquired combination of illumination of the LED array 55 is reflected on the mirrors 45A and 45B.

The controller 60 may be an electronic controller including a central processing unit (CPU), a read only memory (ROM), and a random access memory (RAM). The controller 60 may be configured as, for example, software in which a program stored in the ROM is loaded onto the RAM and executed by the CPU. The controller 60 may be configured as hardware such as an electronic circuit. The controller 60 transmits a transport command to cause the traveling vehicle 6 to transport the article 10.

In the traveling vehicle system 1 having such a configuration, as illustrated in FIG. 1, among three traveling vehicles 6 included in the traveling vehicle system 1 that travel in succession, when the traveling vehicle located at the front (most downstream) is referred to as a first traveling vehicle 6A, the traveling vehicle 6 located in the middle is referred to as a second traveling vehicle 6B, and the traveling vehicle 6 located at the rear (most upstream) (the subject vehicle) is referred to as a third traveling vehicle 6C, the third traveling vehicle 6C acquires both the traveling state of the first traveling vehicle 6A and the traveling state of the second traveling vehicle 6B based on the display mode (information output by the information output interface) of the LED array 55 of the second traveling vehicle 6B, the third traveling vehicle 6C travels based on both the traveling state of the first traveling vehicle 6A and the traveling state of the second traveling vehicle 6B, and further, the third traveling vehicle 6C switches the display modes of the LED array 55 of the subject vehicle based on both the traveling state of the subject vehicle and the traveling state of the second traveling vehicle 6B.

In addition, in the traveling vehicle system 1 of the present example embodiment, in a case where the traveling vehicles 6 travel in succession with the branch portion 41 interposed therebetween, the traveling vehicle 6 located on the upstream side of the branch portion 41 (that is, the inflow path 41A) recognizes, as the preceding traveling vehicle 6, the traveling vehicle 6 located on the first outflow path 41B or the second outflow path 41C that is about to travel. As described above, the traveling vehicle 6 located on the inflow path 41A can capture an image of the LED array 55 of the traveling vehicle 6 located on the first outflow path 41B, and can also capture an image of the LED array 55 of the traveling vehicle 6 located on the second outflow path 41C via the mirror 45A.

In addition, in the traveling vehicle system 1 of the present example embodiment, in a case where the traveling vehicles 6 travel in succession with the merging portion 43 interposed therebetween, the traveling vehicle 6 located on the upstream side of the merging portion 43, that is, located on the first inflow path 43A or the second inflow path 43B, recognizes the traveling vehicle 6 merging first as the preceding traveling vehicle 6 in consideration of the order after merging. As described above, the traveling vehicle 6 located on the first inflow path 43A can capture an image of the LED array 55 of the traveling vehicle 6 located on the second inflow path 43B via the mirror 45B, and the traveling vehicle 6 located on the second inflow path 43B can capture an image of the LED array 55 of the traveling vehicle 6 located on the first inflow path 43A via the mirror 45B.

A characteristic operation of the traveling vehicle system 1 of the present example embodiment will be described. The traveling vehicle 6 monitors a distance to an obstacle (including a traveling vehicle) ahead using an obstacle sensor or the like that monitors the front. Each of the traveling vehicles 6 provided in the traveling vehicle system 1 decelerates when a distance to an obstacle (including the traveling vehicle 6) ahead reaches the first predetermined distance, and stops when the distance to the obstacle ahead reaches the second predetermined distance shorter than the first predetermined distance. In the traveling vehicle system 1 having the above-described configuration, the third traveling vehicle 6C can also control the traveling assembly 18 based on the traveling state of only the traveling vehicle 6 directly ahead (second traveling vehicle 6B) of the subject vehicle in the traveling direction. The second traveling vehicle 6B may accelerate or decelerate depending on the distance from the first traveling vehicle 6A.

Here, even if the second traveling vehicle 6B decelerates, when the first traveling vehicle 6A is in the accelerated state, the second traveling vehicle 6B sometimes accelerates immediately. Taking such a situation into consideration, in the third traveling vehicle 6C of the present example embodiment in which the traveling state of the first traveling vehicle 6A and the traveling state of the second traveling vehicle 6B can be acquired, when it is acquired that the traveling state of the first traveling vehicle 6A is the accelerated state and the traveling state of the second traveling vehicle 6B is the decelerated state, it is possible to control the third traveling vehicle 6C to continue traveling at a constant speed or to accelerate instead of following the traveling state of the second traveling vehicle 6B. As a result, unnecessary acceleration/deceleration in the third traveling vehicle 6C can be reduced, which improves the transport efficiency (processing capacity).

Further, even if the second traveling vehicle 6B accelerates, when the first traveling vehicle 6A is in the decelerated state, the second traveling vehicle 6B sometimes decelerates immediately. Taking such a situation into consideration, in the third traveling vehicle 6C of the present example embodiment in which the traveling state of the first traveling vehicle 6A and the traveling state of the second traveling vehicle 6B can be acquired, when it is acquired that the traveling state of the first traveling vehicle 6A is the decelerated state and the traveling state of the second traveling vehicle 6B is the accelerated state, it is possible to control the third traveling vehicle 6C to continue traveling at a constant speed or to decelerate instead of following the traveling state of the second traveling vehicle 6B. As a result, unnecessary acceleration/deceleration in the third traveling vehicle 6C is reduced, which improves the transport efficiency (processing capacity).

The operational effects of the traveling vehicle 6 and the traveling vehicle system 1 of the above example embodiment will be described. In the traveling vehicle system 1 and the traveling vehicle 6 of the above example embodiment, both the traveling state of the second traveling vehicle 6B (subject vehicle) and the traveling state of the first traveling vehicle 6A (preceding traveling vehicle 6) can be transmitted to the third traveling vehicle 6C (following traveling vehicle 6). This allows the third traveling vehicle 6C, which has acquired both the traveling state of the second traveling vehicle 6B and the traveling state of the first traveling vehicle 6A, to not only follow the traveling state of the second traveling vehicle 6B directly ahead of the subject vehicle in the traveling direction but also control the traveling assembly 18 based on the traveling state of the first traveling vehicle 6A two vehicles ahead. As a result, it is possible to not only quickly execute operations according to traveling states of a plurality of traveling vehicles 6 located in front of the subject vehicle, but also improve the traveling efficiency of the subject vehicle.

More specifically, if the state of acceleration/deceleration of the first traveling vehicle 6A is known, an expected value of the speed of the second traveling vehicle 6B can also be determined, and if the expected value of the speed of the second traveling vehicle 6B is known, an expected value of the third traveling vehicle 6C can also be determined. By controlling the traveling assembly 18 in accordance with such an expected value of the third traveling vehicle 6C, unnecessary acceleration/deceleration in the third traveling vehicle 6C can be eliminated, and a decrease in speed of the third traveling vehicle 6C can be avoided, so that traveling efficiency (processing capacity) of the entire traveling vehicle system 1 can be enhanced.

The traveling vehicle 6 and the traveling vehicle system 1 of the above example embodiment include the LED array 55 that switches the display modes in accordance with the traveling states of the subject vehicle and the traveling vehicle 6 located in front of the subject vehicle, and the imager 8 that captures an image of the LED array 55 provided on the traveling vehicle 6 located in front of the subject vehicle. With this configuration, a communication failure due to a temporal change in a communication environment is unlikely to occur, information can be transmitted stably, and responsiveness can be enhanced.

In the traveling vehicle 6 and the traveling vehicle system 1 of the above example embodiment, the controller 50 may be configured or programmed to control the traveling assembly 18 to decelerate to the first speed when the distance to the traveling vehicle 6 located in front of the subject vehicle reaches the first predetermined distance, and may control the traveling assembly 18 to stop when the distance reaches the second predetermined distance shorter than the first predetermined distance. With this configuration, it is possible to enhance the transport capability while executing control capable of preventing the traveling vehicles 6 and 6 from colliding with each other.

In the traveling vehicle 6 and the traveling vehicle system 1 of the above example embodiment, the traveling state (accelerated state or decelerated state) of the subject vehicle and the traveling state (accelerated state or decelerated state) of the preceding traveling vehicle 6 are transmitted to the following traveling vehicle 6 via the LED array 55. With this configuration, it is possible to transmit, to the following traveling vehicle 6, whether the subject vehicle is in the accelerated state or the decelerated state, and it is possible to transmit, to the following traveling vehicle 6, whether the preceding traveling vehicle 6 is in the accelerated state or the decelerated state.

Although example embodiments have been described above, example embodiments of the present invention are not limited to the above example embodiments. Various modifications can be made without departing from the gist of the present invention.

In the above example embodiments, an example is described in which the traveling state of the traveling vehicle 6 is transmitted to the following traveling vehicle 6 via the LED array 55 as the accelerated state, the normal traveling state, or the decelerated state, but the example embodiments are not limited thereto. For example, instead of or in addition to the normal traveling state or the decelerated state, the traveling state of the traveling vehicle 6 may be transmitted to the following traveling vehicle 6 as an abnormal stop state or a normal stop state. As described above, the abnormal stop state is a state in which the traveling vehicle 6 has transitioned to an operation for abnormal stop, and the normal stop state is a state in which the traveling vehicle 6 has transitioned to an operation for normal stop. The braking distance at the time of abnormal stop is shorter than the braking distance at the time of normal stop.

With this configuration, it is possible for the second traveling vehicle 6B to transmit, to the following traveling vehicle 6, whether the subject vehicle is abnormally stopped or normally stopped, and it is also possible for the second traveling vehicle 6B to transmit, to the following traveling vehicle 6, whether the preceding traveling vehicle 6 located in front of the subject vehicle is abnormally stopped or normally stopped. In other words, the third traveling vehicle 6C can acquire whether the traveling state of the first traveling vehicle 6A and the traveling state of the second traveling vehicle 6B are in an abnormal stop or in a normal stop.

When the preceding traveling vehicle 6 makes an emergency stop, the following traveling vehicle 6 may not be able to stop in time and collide with the preceding traveling vehicle 6. In a case where three or more traveling vehicles 6 are traveling in succession, there is a possibility that further following traveling vehicles 6 collide with each other one after another. In this regard, the traveling vehicle system 1 of the present example embodiment can acquire information that the traveling vehicle 6 two vehicles ahead of the subject vehicle has made an emergency stop, so that quicker response is possible than a case where the traveling assembly 18 is controlled based on information that the traveling vehicle 6 directly ahead of the subject vehicle has made an emergency stop. This can reduce the possibility of a chain reaction collision. In addition, in this configuration, an inter-vehicle distance (that is, the first predetermined distance and the second predetermined distance in the collision prevention control using the obstacle sensor) can be set short and, thus, the transport efficiency of the traveling vehicles 6 in the traveling vehicle system 1 can be enhanced.

In the example embodiments or the modifications described above, an example of using the LED array 55 is described as an example of the information output interface that outputs information to the following traveling vehicle 6 of the subject vehicle, but the example embodiments or the modifications are not limited thereto. Examples of information output include a method using radio waves, a method using infrared communication, and a method using feeder radio. However, the methods of the above example embodiments have advantages that a communication failure is less likely to occur and a communication failure due to a temporal change in a communication environment is less likely to occur as compared with the method using radio waves. In addition, the methods of the above example embodiments have advantages in that the methods are resistant to misalignment of the optical axis as compared with the method using infrared communication. In addition, the methods of the above example embodiments provide an advantage that the signal transmission response is faster (latency is shorter) than the method using feeder radio.

In the example embodiments and the modifications described above, examples have been provided in which the travel state of the traveling vehicle 6 two vehicles ahead is acquired with reference to the subject vehicle. However, appropriate modifications are possible, such as acquiring the driving state of the traveling vehicles 6 up to three vehicles ahead of the subject vehicle using the same technical concept.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-6. (canceled)

7. A traveling vehicle usable in a traveling vehicle system including three or more traveling vehicles traveling in one direction along a predetermined traveling path, the traveling vehicle comprising:
a body;
a traveling assembly configured to allow the body to travel along the traveling path;
an information output interface configured to output information to a following traveling vehicle;
an information acquirer configured to acquire the information output by the information output interface provided in a preceding traveling vehicle located directly ahead of a subject vehicle in a traveling direction; and
a controller configured or programmed to control the traveling assembly; wherein
the information output interface is configured to output to the following traveling vehicle first information according to a state of the subject vehicle and second information according to a state of the preceding traveling vehicle of the subject vehicle acquired by the information acquirer; and
the controller is configured or programmed to control the traveling assembly based on both the first information and the second information output from the preceding traveling vehicle and acquired by the information acquirer.

8. The traveling vehicle according to claim 7, wherein
the information output interface includes a display configured to switch display modes in accordance with the first information or the second information;
the information acquirer includes an imager configured to capture an image of the display provided in the preceding traveling vehicle;
the display is configured to switch display modes based on the first information and the second information; and
the controller is configured or programmed to control the traveling assembly of the subject vehicle based on a display mode of the display of the preceding traveling vehicle captured by the imager.

9. The traveling vehicle according to claim 7, wherein the controller is configured or programmed to control the traveling assembly to decelerate to a first speed when a distance to the preceding traveling vehicle reaches a first predetermined distance and to control the traveling assembly to stop when the distance reaches a second predetermined distance shorter than the first predetermined distance.

10. The traveling vehicle according to claim 7, wherein
the information output interface is configured to switch the information to be output in accordance with a traveling state of the subject vehicle and a traveling state of the preceding traveling vehicle; and
the traveling state includes an accelerated state and a decelerated state.

11. The traveling vehicle according to claim 7, wherein
the information output interface is configured to switch the information to be output in accordance with a traveling state of the subject vehicle and a traveling state of the preceding traveling vehicle; and
the traveling state includes an abnormal stop state and a normal stop state.

12. A traveling vehicle system comprising:
the traveling vehicle according to claim 7; and
three traveling vehicles configured to travel in succession and assumed to correspond to a traveling vehicle located at a front being a first traveling vehicle, a traveling vehicle located in a middle being a second traveling vehicle and a traveling vehicle located at a rear being a third traveling vehicle; and
the third traveling vehicle is configured to acquire both a state of the first traveling vehicle and a state of the second traveling vehicle based on the information output by the information output interface of the second traveling vehicle, the third traveling vehicle is configured to perform traveling control based on both the state of the first traveling vehicle and the state of the second traveling vehicle, and the third traveling vehicle is configured to output both a state of a subject vehicle and the state of the second traveling vehicle from the information output interface of the subject vehicle.
